(19) United States
(12) Patent Application Publication
(10) Pub. No.: US 2006/0128308 A1
(43) Pub. Date: Jun. 15, 2006

(54) Low power bluetooth page and inquiry scan

(75) Inventors: Dan Michael, Udim (IL); Ran Katz, Givataim (IL); Yaniv Tzoreff, Tel Aviv (IL); Adi Dotan, Hod Hasharon (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/280,192

(22) Filed: Nov. 15, 2005

Related U.S. Application Data
(60) Provisional application No. 60/634,855, filed on Dec. 10, 2004.

(51) Int. Cl. H04B 7/00; H04B 1/18

(52) U.S. Cl. 455/41.2; 455/161.1

(57) ABSTRACT

A novel and useful low power Bluetooth page and inquiry scan mechanism. Efficient and low power page and inquiry scans are performed by measuring the energy received at each frequency and comparing it to a threshold. If the energy sensed is greater than the threshold, normal Bluetooth page or inquiry scans are then performed within the scan window. The energy sensing is done by quickly sweeping the receiver in the radio over all 79 Bluetooth frequencies in less than 68 μs at least 19 times in order to cover at least 1.25 ms thus ensuring capturing any page or inquiry message transmissions. For noisy environments, a mechanism is provided to turn frequency sweeping off until interference is at a low enough level to reduce the number of false positive detections to an acceptable level.

### REFERENCE TO RELATED APPLICATIONS

This application claims priority to U.S. Provisional Application Serial No. 60/634,855, filed Dec. 10, 2004, entitled “Power Efficient page and Inquiry Scan Operation Modes in a Bluetooth Radio”, incorporated herein by reference in its entirety.

### FIELD OF THE INVENTION

The present invention relates to the field of data communications and more particularly relates to an apparatus and method for performing low power page and inquiry scans in a Bluetooth compatible network.

### BACKGROUND OF THE INVENTION

Bluetooth is a worldwide specification for a small low-cost radio. Bluetooth networks are intended to link mobile computers, mobile phones, other portable handheld devices and provide Internet connectivity. Bluetooth uses a packet switching protocol employing frequency hopping at 1600 hops/s with a maximum data rate of 1 Mb/s. Bluetooth radios operate in the unlicensed ISM band at 2.4 GHz. A frequency hop transceiver is used to combat interference and fading and a shaped, binary FM modulation is applied to minimize transceiver complexity. The symbol rate is 1 Ms/s. For full duplex transmission, a Time-Division Duplex (TDD) scheme is used. On the channel, information is exchanged through packets. Each packet is transmitted on a different hop frequency. A packet nominally covers a single slot, but can be extended to cover up to five slots.

The slotted channel is divided into time slots, each having a nominal slot length of 625 μs. The time slots are numbered according to the Bluetooth clock of the piconet master. The slot numbering ranges from 0 to 2²⁷⁻¹ and is cyclic with a cycle length of 2²⁷. In the time slots, master and slave can transmit packets. A time-division duplex (TDD) scheme is used where master and slave alternatively transmit. The master starts its transmission in even-numbered time slots only, and the slave starts its transmission in odd-numbered time slots only. The packet start is aligned with the slot start.

A high level Bluetooth transmit path is shown in FIG. 1. The transmit path, generally referenced 100, comprises a link manager 102, Asynchronous Connectionless (ACL) FIFO 104, Synchronous Connection-Oriented (SCO) FIFO 106, link controller 108, Bluetooth radio 110 and antenna 112. FIFO queues are preferred in ACL and SCO links for transmission and reception. The link manager functions to fill these queues and the link controller reads the queues automatically.

If the ACL and SCO FIFO queues become full, flow control is used to avoid dropped packets and congestion. If data cannot be received, a STOP indication is inserted by the link controller at the receiver into the header of the return packet. When the transmitter receives the STOP indication, it freezes its FIFO queues. When the receiver is ready again it sends a GO packet that resumes the flow.

SCO and ACL links are the two types of physical links provided by the Bluetooth baseband. SCO and ACL links may be used on the same channel or physical RF link. SCO links may be used for both audio and data transmissions. Slave devices may transmit SCO data packets without being polled because SCO links have reserved time slots for transmission. ACL links may be used for data transmission only and slaves must be polled before they can transmit data. ACL links also support both symmetric and asymmetric traffic and are used to transmit broadcast messages from the master unit. Traffic within the piconet is controlled by the master unit which allots bandwidth to each slave based on its application needs and available bandwidth.

Bluetooth transceivers use a time-division duplex (TDD) scheme to communicate, alternately transmitting and receiving in a synchronous manner. The piconet is synchronized by the system clock of the master. The Bluetooth Device Address (BD_ADDR) of the master determines the frequency hopping sequence and the channel access code; the system clock of the master determines the phase in the hopping sequence. The master controls the traffic on the channel by a polling scheme. The slaves adapt their native clocks with a timing offset in order to match the master clock.

The channel is represented by a pseudo-random hopping sequence hopping through the 79 RF channels. The hopping sequence is unique for the piconet and is determined by the Bluetooth device address of the master; the phase in the hopping sequence is determined by the Bluetooth clock of the master. The channel is divided into time slots where each slot corresponds to an RF hop frequency. Consecutive hops correspond to different RF hop frequencies. The nominal hop rate is 1600 hops/s. All Bluetooth units participating in the piconet are time and hop synchronized to the channel.

A Bluetooth device can be in one of four possible connection modes: active, hold, sniff or park mode. In active mode, the Bluetooth device actively participates on the channel. Traffic within the channel is scheduled based on the needs of each active device within the piconet. The master supports regular transmissions to keep all the slaves synchronized to the channel. When a Bluetooth device participates actively on a channel, it is assigned an Active Member Address (AM_ADDR).

Hold mode is one of the three reduced power modes available to a Bluetooth device. In hold mode, a Bluetooth transceiver neither transmits nor receives information. When returning to normal operation after a hold mode in a slave Bluetooth unit, the slave must listen for the master before it sends information. The hold mode frees up the unit to accomplish other tasks involving page or inquiry scans. Another reduced power mode, sniff mode, reduces the duty cycle of the slave's listening activity. This mode is primarily used to reduce the amount of power used by a device or to allow a device to time share in participation between two piconets. The third reduced power mode, park mode, enables a unit to not actively participate in the channel but to remain synchronized to the channel and to listen for broadcast messages. A slave in park or sniff mode periodically wakes up to listen to transmissions from the master and to re-synchronize its clock offset.

All Bluetooth devices are in standby mode by default. In standby mode, unconnected devices periodically listen for messages. This procedure is called scanning which is divided into two types: page scan and inquiry scan. Page scan is defined as the connection sub-state in which a device listens for its own device access code (DAC) for duration of the scan window (11.25 ms) and is used to set up an actual connection between devices. Inquiry scan is very similar to page scan except that in this sub-state the receiving device scans for the inquiry access code (IAC). Inquiry scan is used to discover which units are in range and what their device addresses and clocks are. Following a successful scanning procedure one of four possible connection states described above is possible: active, hold, sniff and park. If the scanning procedure was unsuccessful or a connection is not desired by one or both of the devices no connection is made.

During the page scan procedure a device assumes either the role of the master or of the slave. The slave unit device wakes up every 11.25 ms (i.e. the scan window) to listen for its DAC. The scanning performed by the slave unit is done on one frequency hop sequence determined by the hardware within the unit. In the page scan sub-state, a unit listens for its own device access code for the duration of the scan window. During the scan window, the unit listens at a single hop frequency, its correlator matched to its device access code. The scan window is long enough to completely scan 16 page frequencies. It selects the scan frequency according to the page 32-hop hopping sequence corresponding to the unit. Every 1.28 seconds a different frequency is selected.

During the page sub-state, the master repeatedly transmits the slave's DAC in an attempt to form a connection between the devices. This transmission occurs during each of the page hops with the page train. If at any point a response is received from the slave unit, the master unit enters the master response sub-state.

The page sub-state is used by the master (i.e. source) to activate and connect to a slave (i.e. destination) which periodically wakes up in the page scan sub-state. The master tries to capture the slave by repeatedly transmitting the slave's device access code (DAC) in different hop channels. In the page state, the master transmits the device access code (ID packet) corresponding to the slave to be connected, rapidly on a large number of different hop frequencies. Since the ID packet is a very short packet, the hop rate can be increased from 1600 hops/s to 3200 hops/s. Since the Bluetooth clocks of the master and the slave are not synchronized, the master does not know exactly when the slave wakes up and on which hop frequency. Therefore, it transmits a train of identical DACs at different hop frequencies, and listens in between the transmit intervals until it receives a response from the slave.

In a single TX slot interval, the paging master transmits on two different hop frequencies. In a single RX slot interval, the paging transceiver listens on two different hop frequencies. During the TX slot, the paging unit sends an ID packet at the TX hop frequencies f(k) and f(k+1). In the RX slot, it listens for a response on the corresponding RX hop frequencies f′(k) and f′(k+1). The page message consists of the ID packet which is only 68 bits in length, thus there is ample time (224.5 μs minimal) to switch the synthesizer in the paging unit. In the following RX slot, the receiver will listen sequentially to two corresponding RX hops for ID packet. The RX hops are selected according to the page response hopping sequence. The page response hopping sequence is strictly related to the page hopping sequence; that is: for each page hop there is a corresponding page response hop. In the next TX slot, it will transmit on two hop frequencies different from the former ones. The synthesizer hop rate is increased to 3200 hops/s. The timing of the page and inquiry scan transmissions is shown in FIG. 2. Pairs of page or inquiry scan messages 200 are repeated within the scan window in accordance with the Bluetooth specification.

Inquiry procedures involve the same mechanics of the page procedures, the only difference being the information exchanged between the devices. An inquiry procedure is defined which is used in applications where the destination's device address is unknown to the source. While in the inquiry sub-states, the master unit is searching looking for potential slaves and does not have the required DAC needed to establish a connection. The inquiry procedure enables the master device to obtain the required DAC from potential slave units. Within the inquiry procedures, the only information exchanged is the slave unit responding with its address information. Following a successful inquiry scan, the master unit will enter the page procedures in order to establish a connection.

On two consecutive 312.5 μs time slots, the inquiring device broadcasts inquiry packets on two sequential frequencies. During the next two time slots, the device scans for a reply on these same two frequencies. It then moves on to the next two frequencies. This process continues until some specified bound on the number of replies received or the total time is exceeded.

A problem arises, however, in connection with the power consumption of Bluetooth devices. This problem becomes more acute considering that Bluetooth technology is rapidly penetrating into many consumer electronics devices, especially mobile terminals. Reportedly over 100 million Bluetooth enabled mobile devices were shipped in 2004 and it is estimated that over 500 million will ship in 2008.

The problem is that for most of the time (>95%) Bluetooth devices are busy performing page and inquiry scans. Typical Bluetooth solutions faithfully adhere to the Bluetooth specification and therefore must turn on their receivers for the entire 11.25 ms scan window. If the duration and complexity of these procedures can be minimized, power consumption can be minimized resulting in a dramatic increase in the overall system standby time of these devices. Currently, leading Bluetooth products consume an average 400 μA continuously while performing page or inquiry scans. When performing combined page and inquiry scans, these products consume over 800 μA. Worse, there are some applications that require the device to perform multiple page and inquiry scans thus driving the current consumption even higher which dramatically reduces standby time.

There is thus a long felt need for a mechanism that is able to perform a Bluetooth page and inquiry scan at much lower power consumption.

### SUMMARY OF THE INVENTION

The present invention provides a solution to the problems of the prior art by providing a low power Bluetooth page and inquiry scan mechanism. Although the invention is applicable for use in and described in the context of a Bluetooth transceiver, it is appreciated that the invention is not limited for use in Bluetooth environment. The low power frequency scanning mechanism of the present invention can be used in other communication environments as well without departing from the scope of the invention. The invention is applicable in TDM applications where it is necessary to detect the presence of a signal within a particular time slot or window of time. The invention cab be used to quickly and at lower power detect the presence of the desired signal and based on the detection, can trigger regular processing or procedures to be performed.

The present invention is operative to perform fast energy sensing of the Bluetooth spectrum. The energy received at each frequency is measured and compared to a threshold. If the amount of energy sensed is greater than the threshold, regular page or inquiry scans are performed in accordance with the Bluetooth specification. In the case of Bluetooth, the energy sensing is realized by sweeping the receiver in the radio over all 79 Bluetooth frequencies in less than 68 μs repeatedly for at least 1.25 ms (19 such sweeps) thus ensuring capturing any page or inquiry message transmissions (ID packet).

The mechanism is very effective in environments that do not contain many interferers or where the interferers are relatively weak. Implementing the present invention in such an environment results in an average current consumption of less than 100 μA for any combination of required page and inquiry scans.

In noisier environments, the mechanism can potentially generate too many false alarm signals wherein energy is detected in one of the Bluetooth frequencies but was generated by a non-Bluetooth transmitter. In such an event, the present invention provides a further mechanism to turn frequency sweeping off until interference is at a low enough level. This is achieved by counting the number of consecutive false positives received. If the number exceeds a threshold, the low power page and inquiry scan mechanism is disabled for a predetermined time interval. At the end of this time interval, the mechanism is re-enabled and remains operative if the level of interference is sufficiently reduced.

Note that many aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a method of page and inquiry scanning in a Bluetooth compatible transceiver, the method comprising the steps of scanning all Bluetooth frequencies within a time period less than or equal to the duration of a page or inquiry scan message and measuring energy received at each frequency scanned, comparing the received energy against a first threshold and if greater, generating a detection signal and repeatedly performing the steps of scanning and comparing a predetermined number of times.

There is also provided in accordance with the invention, an apparatus for use with a radio receiver for scanning a range of RF frequencies for a message having a first duration comprising frequency scanning means for performing a predetermined number of frequency sweeps over the range of frequencies, the frequency scanning means comprising means for completing each frequency sweep within a time period less than or equal to the first duration, means for measuring the energy received at each frequency and means for comparing the received energy with a first threshold and for generating a detection signal if the received energy is greater than the first threshold.

There is further provided in accordance with the invention, an Bluetooth communications device comprising a Bluetooth radio comprising a transmitter and a receiver, a frequency scanner coupled to the receiver for performing a predetermined number of frequency sweeps over all Bluetooth frequencies, wherein each frequency sweep is competed within a time period less than or equal to the duration of a page or inquiry scan message, an energy detector means coupled to the receiver for measuring the energy received by the receiver at each frequency and means for comparing the received energy with a first threshold and for generating a detection signal if the received energy is greater than the first threshold.

### BRIEF DESCRIPTION OF THE DRAWINGS

The invention is herein described, by way of example only, with reference to the accompanying drawings, wherein:

FIG. 1 is a block diagram illustrating the transmit path of a prior art Bluetooth transceiver;

FIG. 2 is a diagram illustrating the timing of Bluetooth page and inquiry scan messages within a scan window;

FIG. 3 is a diagram illustrating the frequency sweeping mechanism of the present invention as a function of time;

FIG. 4 is a block diagram illustrating the lower power scan mechanism of the present invention utilizing analog energy detection;

FIG. 5 is a block diagram illustrating the low power page and inquiry scan mechanism of the present invention applied to a Bluetooth radio;

FIG. 6 is a diagram illustrating the status and control data used in the low power scan mechanism of the present invention;

FIG. 7 is a block diagram illustrating the low power page and inquiry scan mechanism of the present invention incorporating a bank of energy detectors;

FIG. 8 is a flow diagram illustrating the fast sweep method of the present invention; and

FIG. 9 is a flow diagram illustrating the fast sweep minimization method of the present invention.

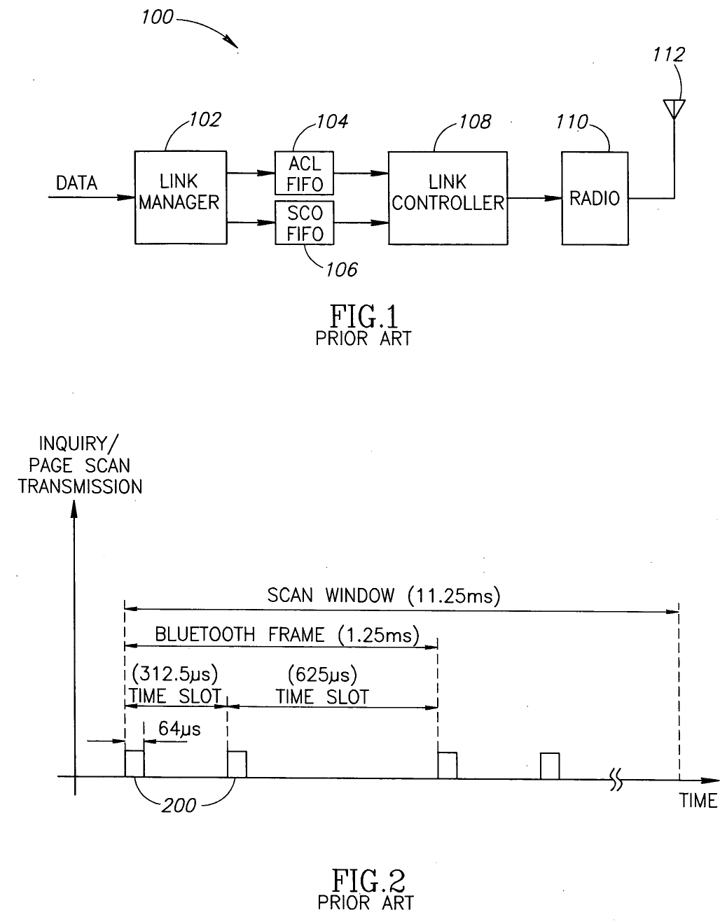

| Term | Definition |
|---|---|
| ACL | Asynchronous Connectionless |
| ADC | Analog to Digital Converter |
| ASIC | Application Specific Integrated Circuit |
| DAC | Digital to Analog Converter |
| DSP | Digital Signal Processor |
| FIFO | First In First Out |
| FPGA | Field Programmable Gate Array |
| HDL | Hardware Description Language |
| IAC | Inquiry Access Code |
| IC | Integrated Circuit |
| ISM | Industrial Scientific Medical |
| LO | Local Oscillator |
| RAM | Random Access Memory |
| RF | Radio Frequency |
| ROM | Read Only Memory |
| RSSI | Received Signal Strength Indicator |
| SCO | Synchronous Connection-Oriented |
| TDD | Time Division Duplex |
| TDM | Time Division Multiplexing |
| WLAN | Wireless Local Area Network |

### DETAILED DESCRIPTION OF THE INVENTION

### Notation Used Throughout

The following notation is used throughout this document.

### DETAILED DESCRIPTION OF THE INVENTION

The present invention provides a solution to the problems of the prior art by providing a low power Bluetooth page and inquiry scan mechanism. The invention is applicable in TDM applications where it is necessary to detect the presence of a signal within a particular time slot or window of time. The invention cab be used to quickly and at lower power detect the presence of the desired signal and based on the detection, can trigger regular processing or procedures to be performed.

To aid in understanding the principles of the present invention, the low power frequency scanning mechanism is provided in the context of a Bluetooth transceiver. In particular, the invention is applied to the task of detecting the transmission of page or inquiry messages from a master device. Although the invention is applicable for use in and described in the context of a Bluetooth transceiver, it is appreciated that the invention is not limited for use in Bluetooth environment. The low power frequency scanning mechanism of the present invention can be used in other communication environments as well without departing from the scope of the invention.

The present invention is operative to perform fast energy sensing of the Bluetooth spectrum. The energy received at each frequency is measured and compared to a threshold. If the amount of energy sensed is greater than the threshold, regular page or inquiry scans are performed in accordance with the Bluetooth specification. In the case of Bluetooth, the energy sensing is realized by sweeping the receiver in the radio over all 79 Bluetooth frequencies in less than 68 μs at least 19 times in order to cover at least 1.25 ms thus ensuring capturing any page or inquiry message transmissions.

The mechanism is very effective in environments that do not contain many interferers or where the interferers are relatively weak. Implementing the present invention in such an environment results in an average current consumption of less than 100 μA for any combination of required page and inquiry scans.

In noisier environments, the mechanism can potentially generate too many false alarm signals wherein energy is detected in one of the Bluetooth frequencies but was generated by a non-Bluetooth transmitter. In such an event, the present invention provides a further mechanism to turn frequency sweeping off until interference is at a low enough level. This is achieved by counting the number of consecutive false positives received. If the number exceeds a threshold, the low power page and inquiry scan mechanism is disabled for a predetermined time interval. At the end of this time interval, the mechanism is re-enabled and remains operative if the level of interference is sufficiently reduced.

Note that throughout this document, the term communications device is defined as any apparatus or mechanism adapted to transmit, receive or transmit and receive data through a medium. The communications device may be adapted to communicate over any suitable medium such as RF, wireless, infrared, optical, wired, microwave, etc. In the case of wireless communications, the communications device may comprise an RF transmitter, RF receiver, RF transceiver or any combination thereof.

As described supra, most of the time Bluetooth devices are not connected to another device and are in a standby mode. While in this mode, the device is scanning, i.e. waiting either for a device to connect to it or to do some kind of device discovery. Once every second the wakes up for 11.25 ms, turns on its receiver and waits. It then turns its receiver off and waits until the next period.

The present invention is able to reduce the 11.25 ms to 1.25 ms thus significantly reducing current consumption. Considering the Bluetooth discovery or connection process, the present invention recognizes that the device doing discovery transmits page or inquiry packets in pairs. With each pair, the packets are 312 microseconds apart from each other and pairs of packets are transmitted every 625 microseconds. Only one of these packets need be detected. In order to insure at the detection of at least one packet, a scan duration of at least 1.25 ms must be performed since the packets are transmitted asynchronously within the Bluetooth frame.

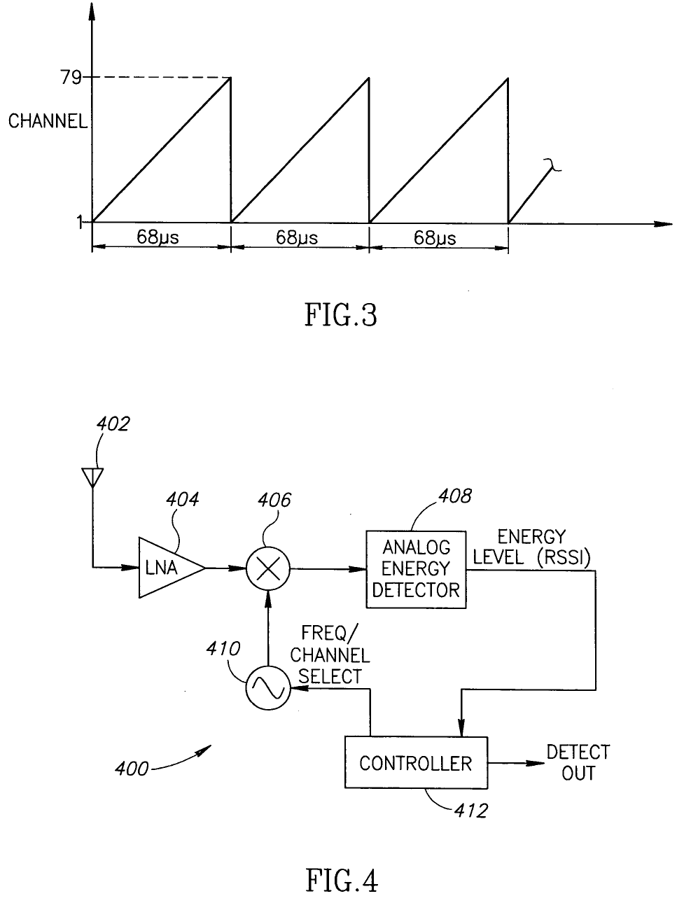

Not only is the timing of the packet transmission not known but its frequency is not known as well. Thus, the entire range of possible frequencies within the time frame of a single packet must be scanned. As the length of a Bluetooth page or inquiry packet is 68 microseconds, all 79 possible frequencies must be scanned within a packet duration to insure the packet is detected, as shown in FIG. 3. Thus, radio wakes up every 1.28 seconds in accordance with the specification, but within 1.25 ms all frequencies are scanned fast enough to make sure that if there is another device searching it will be detected.

The radio is swept over all Bluetooth frequencies and the received energy is measured. A requirement of the radio is that is can support scanning at sufficient speeds to detect the presence of the page or inquiry scan packets. For Bluetooth, the radio is required to scan over all frequencies within 68 microseconds. Note that scanning is performed over time and frequency.

A block diagram illustrating the lower power scan mechanism of the present invention utilizing analog energy detection is shown in FIG. 4. The circuit, generally referenced 400, comprises an antenna 402, amplifier 404, mixer 406, local oscillator (LO) 410, analog energy detector 408 and controller 412.

In operation, the controller generates a frequency or channel select to control the output of the local oscillator. During scanning, the LO is swept over all possible frequencies within the time duration of the page or inquiry scan message width. The energy (e.g., RSSI) received at each frequency is measured using analog means via the energy detector 408. If the energy detected is exceeds a threshold, a detect out signal is generated indicating the presence of a page or inquiry packet.

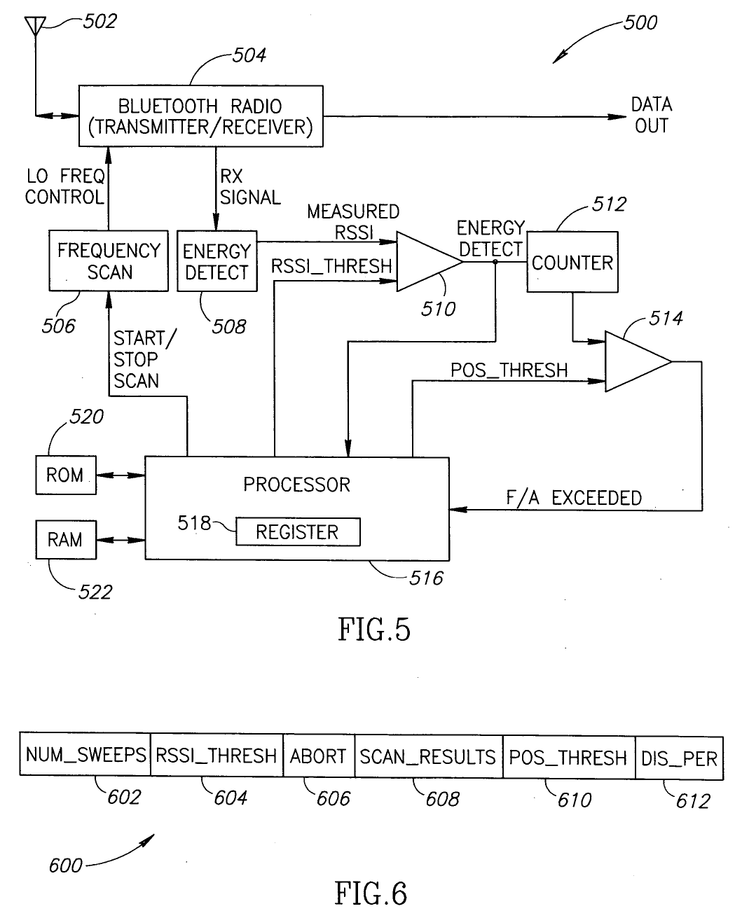

A block diagram illustrating the low power page and inquiry scan mechanism of the present invention applied to a Bluetooth radio is shown in FIG. 5. In this digital embodiment, the circuit, generally referenced 500, comprises an antenna 502, Bluetooth radio (transmitter and receiver) 504, frequency scan unit 506, energy detect unit 508, comparators 510, 514, counter 512, processor 516, register 518, ROM 520 and RAM 522.

In operation, the processor controls the scanning procedure by directing the frequency scan unit to start/stop scanning. The radio is adapted to perform a full sweep in less then 68 microseconds and to repeat the sweep a configurable number of times. Further, the software, as stored in the ROM, is adapted to decide whether to open the scan window based on the results of the sweep.

To initiate a fast sweep operation, the radio and associated circuits require (1) a ‘start’ command, (2) the number of sweeps num_sweeps to complete, and (3) a threshold rssi_thresh to compare the measured energy against

The start command is issued by the software running on the processor. The software writes the command to a specific register in the radio. The register, shown in FIG. 6 and generally referenced 600, comprises num_sweeps 602, rssi_thresh 604, abort 606, scan_results 608, pos_thresh 610 and dis_per 612.

The num_sweeps is the required number of sweeps to be performed. This parameter is written to the register 602. The software is responsible for writing the num_sweeps prior to the issuing of the start command. Preferably, the num_sweeps is set such that the total time duration of the fast sweeps will be ¾ of a Bluetooth frame. This is to make sure an ID packet (i.e. page or inquiry packet) is not missed.

The rssi_thresh parameter is the threshold that the fast sweep results (i.e. measured energy) are compared to. It is written to register 604 in the radio. The software is responsible for writing the rssi_thresh prior to the issuing of the sweep start command.

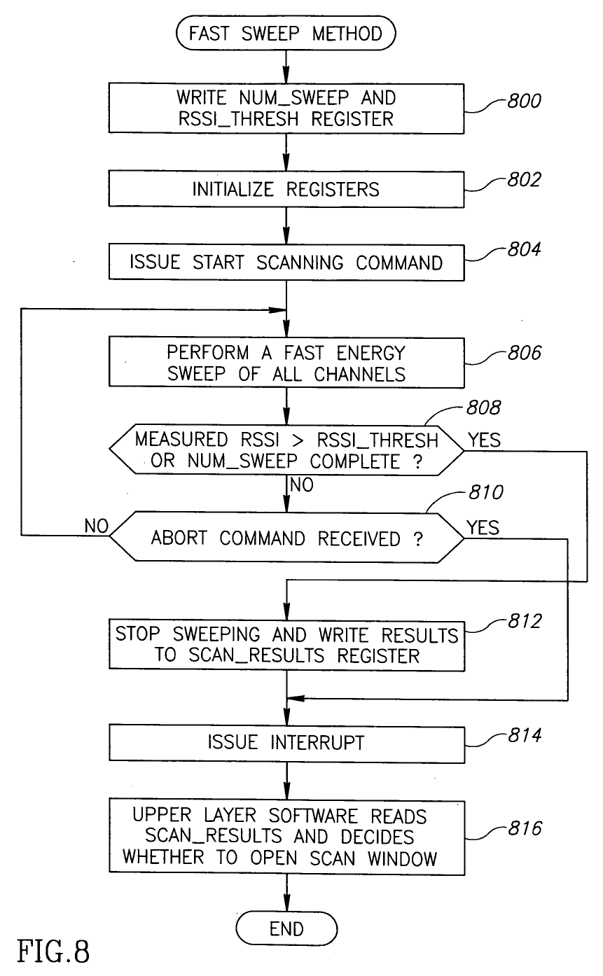

Once the start command issued, the radio performs the fast sweep method shown in FIG. 8. With reference to FIGS. 5 and 8, the num_sweeps and rssi_thresh parameters are written to registers 518 (step 800). Other parameters are initialized at this time as well (step 802). The start scanning (sweeping) command is given (step 804) by the processor to the frequency scan unit 506. A fast sweep of all Bluetooth frequencies (i.e. channels) is performed (step 806). During each sweep, the energy (i.e. RSSI) of each of the 79 Bluetooth frequencies is measured by the energy detect unit 508. Each measured RSSI is compared to the configured threshold rssi_thresh (step 808) via comparator 510 which is operative to output an energy detect signal. The energy detect signal is input to counter 512 and the processor 518. Note that the threshold rssi_thresh is preferably obtained empirically by trial and error. If the measured RSSI exceeds the threshold, the fast sweep method is halted (i.e. the processor issues a stop command) and the results of the sweep are written to a dedicated register scan_results 608 (step 812). A ‘sweep end’ interrupt is then issued (step 814) and upper layer software reads scan_results register and makes a decision as to whether to open a scan window (step 816).

Alternatively, the scan (sweep) process is also halted if the configured num_sweeps have completed (step 808) or if an abort command is received (step 810). If an abort command is received, an interrupt is issued (step 814). Thus, the fast sweep method is halted if any one of the following occurs: (1) RSSI measured exceeds the configured threshold; (2) the configured number of sweeps (num_sweeps) has been completed; and (3) the software issues an abort command.

The results of the fast sweep are written to a dedicated register scan_results in the radio. The software reads the result after it receives a sweep end interrupt and decides in accordance with the results, whether or not to open a scan window.

If the device is located in a noisy environment, energy from non-Bluetooth devices may be detected, e.g., wireless access points, other communication devices in the ISM band, etc. If the level of noise is too great, the device will detect energy and open a standard scan window for 11.25 ms but will not detect another Bluetooth device. The additional processing (i.e. waking up and scanning) to perform the sweep is wasteful in this case. To minimize this waste of power and increase battery life, the invention provides a mechanism to disable the frequency sweeps if too many false positives are detected. A false positive is defined as signal detected but from a non-Bluetooth device.

If the device is in a noisy environment (e.g., near another Bluetooth piconet or an active WLAN), then the fast frequency sweeps will always yield a positive result. To minimize this waste of power, the device counts the number of consecutive false positives and if it exceeds a threshold (pos_thresh), the fast frequency sweep feature is disabled for a configurable period of time (dis_per).

The counting can be performed either by software running on the processor or in dedicated hardware as shown in FIG. 5. If performed in hardware, the counter 512 counts the number of positives. The counter value is compared to the pos_thresh via comparator 514. If the count exceeds the threshold, a false alarm signal (F/A exceeded) is sent to the processor. The processor then stops the fast sweep (by issuing a stop command to the frequency scan unit) for a configurable period of time dis_per. The counter is reset after a negative result is received (i.e. the rssi_thresh was not exceeded).

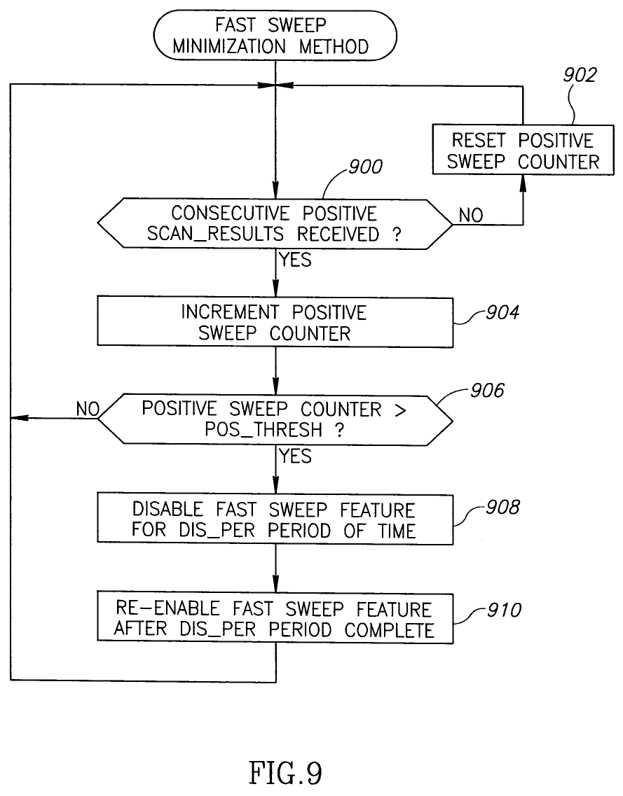

A flow diagram illustrating the fast sweep minimization method of the present invention is shown in FIG. 9. In the case of a software implementation of the minimization scheme, this method is performed by the processor 516 (FIG. 5). The scan result is first checked (step 900). After every positive scan result received, a positive sweep counter is incremented (step 904). If a negative result is received, the positive sweep counter is reset (step 902). The positive sweep counter is compared to the pos_thresh threshold (step 906). If the counter exceeds the threshold, the software disables the fast sweep feature for dis_Per period of time (step 908). After the time period is complete, the processor re-enables the fast sweep feature (step 910).

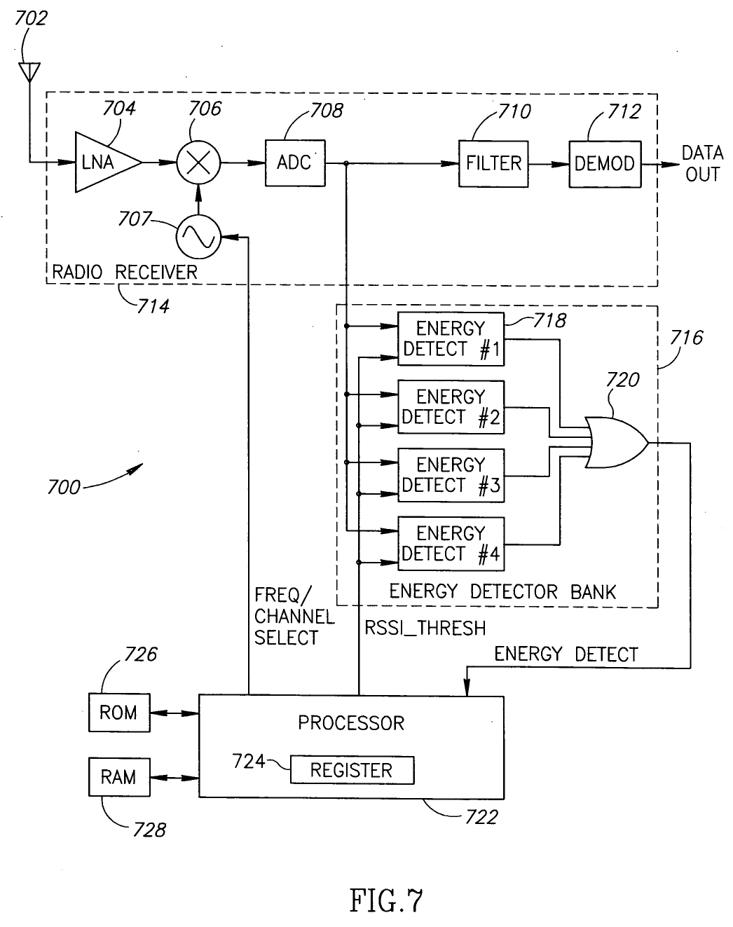

A block diagram illustrating the low power page and inquiry scan mechanism of the present invention incorporating a bank of energy detectors is shown in FIG. 7. In this example embodiment, the frequency scanning mechanism is implemented in a digital radio incorporating a bank of energy detectors. The circuit, generally referenced 700, comprises an antenna 702, radio receiver 714 (e.g., Bluetooth), mixer 706, analog to digital converter (ADC) 708, one or more filters 710, demodulator 712, local oscillator (LO) 707, energy detector bank 716 comprising a plurality of energy detectors 718 and OR gate 720, processor 722 comprising registers 724, ROM 726 and RAM 728.

In operation, the processor controls the scanning procedure by controlling the LO frequency output via the frequency/channel select control signal. Frequency sweeps are performed by quickly sending frequency select commands to the LO such that a frequency sweep of all Bluetooth frequencies is achieved is less than 68 microseconds and to repeat the sweep a configurable number of times. The received signal is converted to the digital domain via the ADC and the output of the ADC is input to a bank of energy detectors, each detector measuring a different channel. A plurality of energy detectors is used in parallel to speed up the detection process by decreasing the number of frequency changes by the LO. The results generated by the four detectors are ORed together via gate 720 and the resultant energy detect signal is read by the processor. The processor is adapted to perform the methods of FIGS. 8 and 9 thus reducing the power consumption required to implement Bluetooth page and inquiry scans.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of page and inquiry scanning in a Bluetooth compatible transceiver, said method comprising the steps of:
scanning all Bluetooth frequencies within a time period less than or equal to the duration of a page or inquiry scan message and measuring energy received at each frequency scanned;
comparing the received energy against a first threshold and if greater, generating a detection signal; and
repeatedly performing said steps of scanning and comparing a predetermined number of times.

2. The method according to claim 1, wherein said time period is approximately 68 microseconds.

3. The method according to claim 1, wherein said step of measuring received energy comprises measuring a received signal strength indication (RSSI) and wherein said first threshold comprises an RSSI threshold.

4. The method according to claim 1, wherein said step of comparing comprises ceasing scanning if said received energy is greater than said first threshold.

5. The method according to claim 1, further comprising the step of ceasing scanning after said step of scanning is performed said predetermined number of times.

6. The method according to claim 1, wherein said predetermined number of times is set such that total scanning time is equal to at least three quarters of the duration of a Bluetooth frame.

7. The method according to claim 1, further comprising ceasing said step of scanning for a predetermined period of time if a number of false detection signals generated exceeds a second threshold.

8. The method according to claim 1, adapted to be implemented in an Application Specific Integrated Circuit (ASIC).

9. The method according to claim 1, adapted to be implemented in a Field Programmable Gate Array (FPGA).

10. An apparatus for use with a radio receiver for scanning a range of RF frequencies for a message having a first duration, comprising:
frequency scanning means for performing a predetermined number of frequency sweeps over said range of frequencies, said frequency scanning means comprising means for completing each frequency sweep within a time period less than or equal to said first duration;
means for measuring the energy received at each frequency; and
means for comparing the received energy with a first threshold and for generating a detection signal if said received energy is greater than said first threshold.

11. The apparatus according to claim 10, wherein said radio receiver comprises a Bluetooth receiver.

12. The apparatus according to claim 10, wherein said predetermined number of frequency sweeps is set such that total scanning time is equal to at least three quarters of the duration of a Bluetooth frame.

13. The apparatus according to claim 10, wherein said message comprises a Bluetooth page or inquiry scan message having a duration of approximately 68 microseconds.

14. The apparatus according to claim 10, wherein said means for measuring comprises means for measuring a received signal strength indication (RSSI) and wherein said first threshold comprises an RSSI threshold.

15. The apparatus according to claim 10, wherein said means for frequency scanning is operative to cease scanning if said received energy is greater than said first threshold.

16. The apparatus according to claim 10, further comprising means for halting scanning for a predetermined period of time if a number of false detection signals generated exceeds a second threshold.

17. The apparatus according to claim 10, adapted to be implemented in an Application Specific Integrated Circuit (ASIC).

18. The apparatus according to claim 10, adapted to be implemented in a Field Programmable Gate Array (FPGA).

19. A Bluetooth communications device, comprising:
a Bluetooth radio comprising a transmitter and a receiver;
a frequency scanner coupled to said receiver for performing a predetermined number of frequency sweeps over all Bluetooth frequencies, wherein each frequency sweep is competed within a time period less than or equal to the duration of a page or inquiry scan message;
an energy detector means coupled to said receiver for measuring the energy received by said receiver at each frequency; and
means for comparing the received energy with a first threshold and for generating a detection signal if said received energy is greater than said first threshold.

20. The apparatus according to claim 19, wherein said predetermined number of frequency sweeps is set such that total scanning time is equal to at least three quarters of the duration of a Bluetooth frame.

21. The apparatus according to claim 19, wherein said energy detector is adapted to measure received signal strength indication (RSSI).

22. The apparatus according to claim 19, further comprising means for halting frequency scanning if said received energy exceeds said first threshold.

23. The apparatus according to claim 19, further comprising means for halting scanning for a predetermined period of time if a number of false detection signals generated exceeds a second threshold.

24. The apparatus according to claim 19, adapted to be implemented in an Application Specific Integrated Circuit (ASIC).

25. The apparatus according to claim 19, adapted to be implemented in a Field Programmable Gate Array (FPGA).
